(19) United States
(12) Patent Application Publication
(10) Pub. No.: US 2009/0134050 A1
(43) Pub. Date: May 28, 2009

(54) Blade solution

(76) Inventor: Albert Jayroe Miller, III, Spokane, WA (US)

Correspondence Address: Albert J. Miller III, 1108 E. Everett Ave, Spokane, WA, 99207, US

(21) Appl. No.: 11/977,126

(22) Filed: Nov. 28, 2007

(51) Int. Cl. B65D 85/00; B23D 59/00

(52) U.S. Cl. 206/374; 206/483; 206/445; 206/493; 206/516

(57) ABSTRACT

The invention is a multi functional box for storing circular tool accessories . The blade solution would contain and organize circular blades. The storage box would allow a blade for cutting metal, masonry, plywood, plastic, framing lumber and concrete all within one location. The make up of the invention is a box, inserts, latch and hinge. All pieces manufacture out of light metal or plastic for durability. The invention would still remain light and small enough so a person could carry from one place to another by means of the handle. Once the desired blades are in place, the container latches closed and the inserts sit inside. The compact design allows a person to keep it within another storage container if desired.

### OVERALL DESCRIPTION OF THE INVENTION

This invention relates to the circular saw blade and grinder wheels. The current invention would be manufactured as a latchable storage box as shown in FIGS. 1-9, with a handle for mobility and portability. The box's exterior shell would be made of a lightweight material such as a rigid plastic, fiberglass or thin gauge metal. Essentially, the invention is designed as an organizer for circular saw blades and grinding/cutting wheels. It would allow for the safe keep, separation, and organization of 10 plus blades and wheels. The blades and wheels contained within the invention may be made interchangeable. That is, a person may have a different number of blades than wheels at any given time.

In some cases, it may be desirable to carry seven different saw blades and four different wheels, for example, and to switch the invention to carry ten different blades and one wheel. Therefore, the inserts contained within the box will remain removable and interchangeable. The inserts will be of two distinct styles. One will allow for the blade to clip in, and the other will allow the blade to seat in a recessed area.

It is the overall objective of the present invention to provide a new method of safeguarding and organizing saw blades and wheels in a convenient manner. In order to meet the overall objective, it was essential to maintain a “box” style storage container. The box would initially employ a traditional latch and handle set up, opened by a single, full width hinge. If desirable by the consumer, the inserts and separators should be able to be placed inside of a tool bag, while serving as a continuation of the objective stated above. The box, or bag depending on preference, should have drain holes in order to allow liquids to escape.

### IN THE DRAWINGS

FIG. 1. A one dimensional side view of the outside of the present invention.

FIG. 2. The same side view as FIG. 1, incorporating the groove insert for a saw blade.

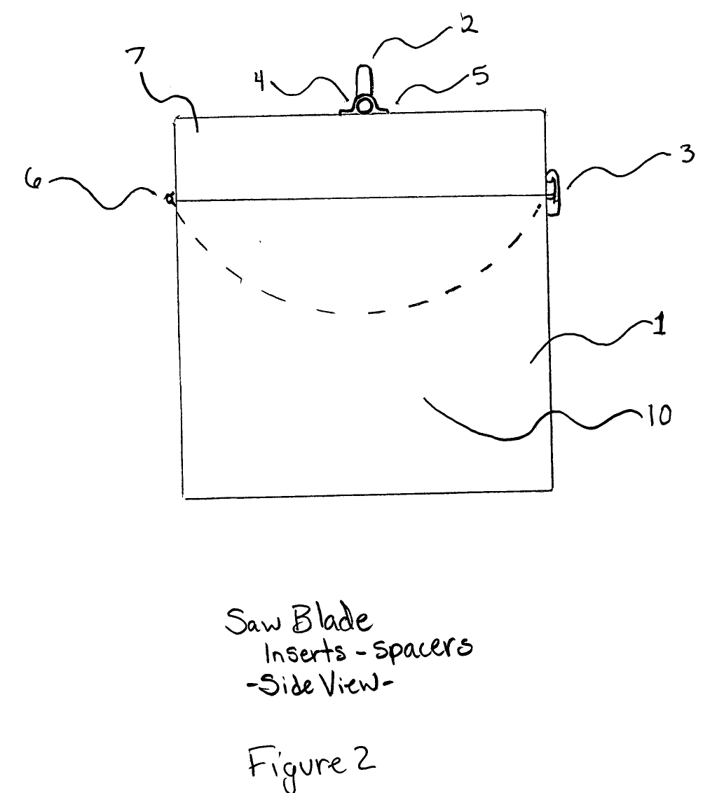

FIG. 3. FIG. 3 shows the front view of the box and the frontal direction of the inserts.

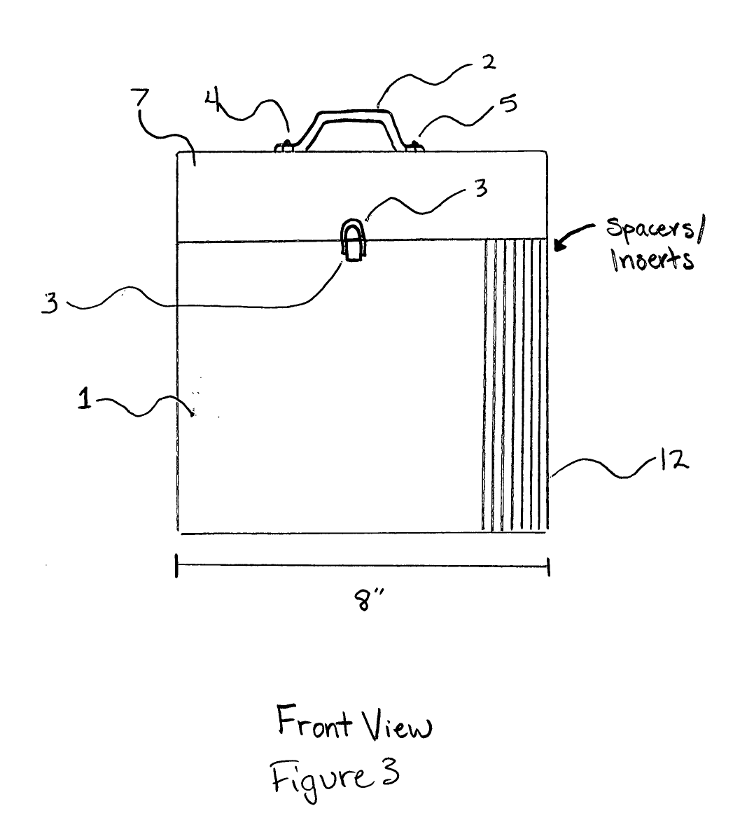

FIG. 4. The demonstration of the top view of the present invention, in 3-D with the inserts in place.

FIG. 5. A view of the saw blade as it would sit in its potential place inside of the box, within a groove style insert.

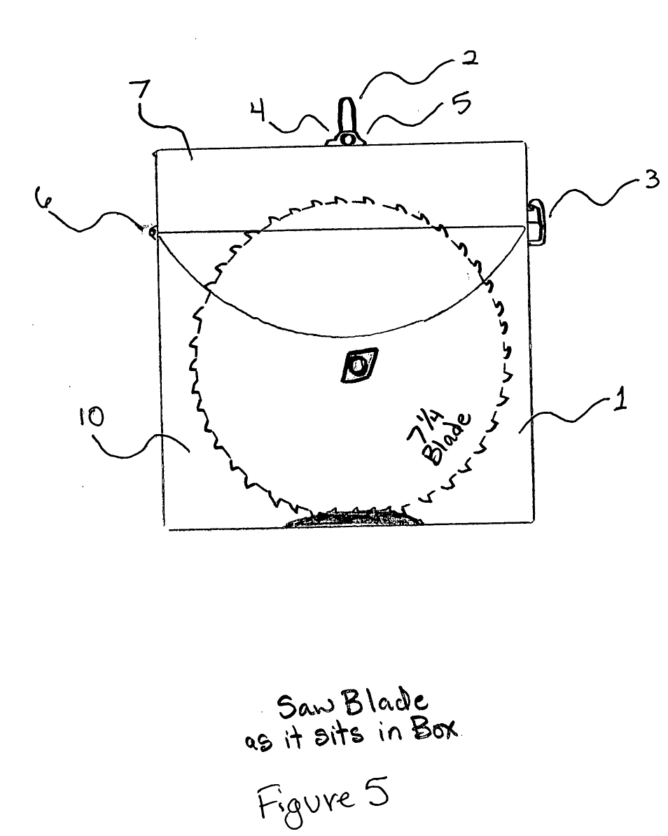

FIG. 6. The side glimpse of a groove style insert for the saw blade.

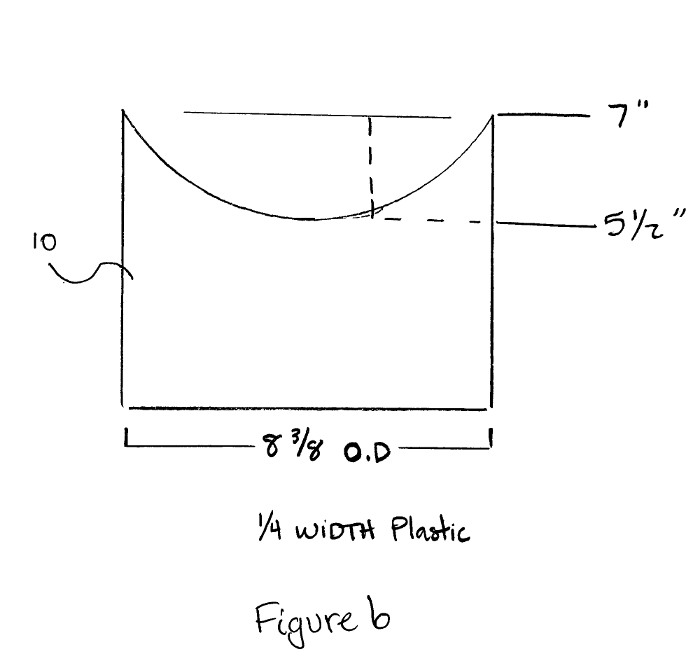

FIG. 7. A drawing of a grinding wheel as it would sit in place.

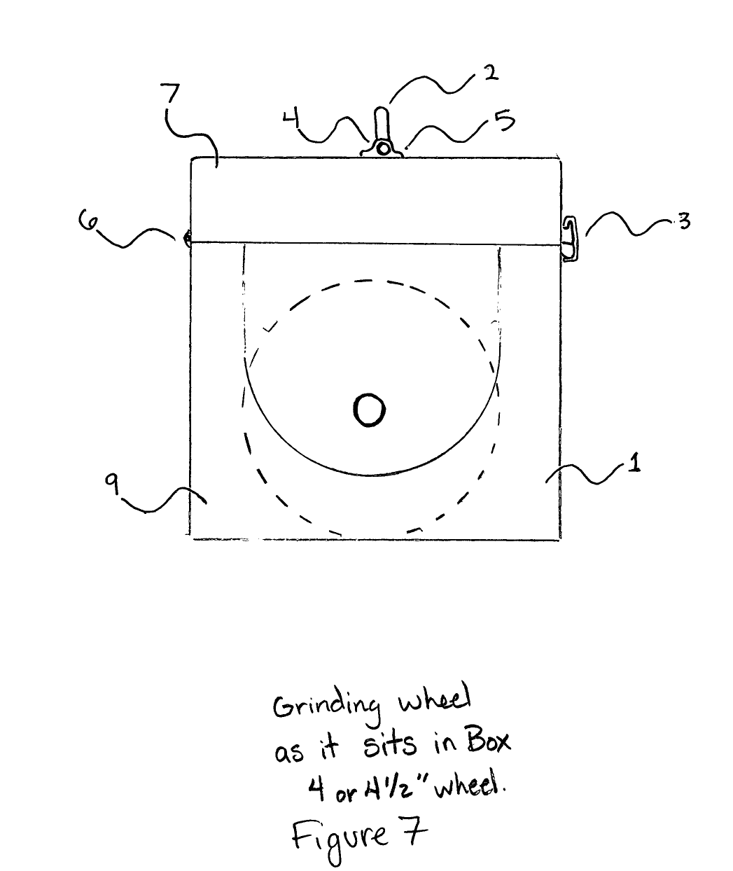

FIG. 8. This figure shows the side view of the groove insert for a grinding wheel as it is contained within the box.

FIG. 9. The sketch in FIG. 9 is of a groove style insert for grinding wheels.

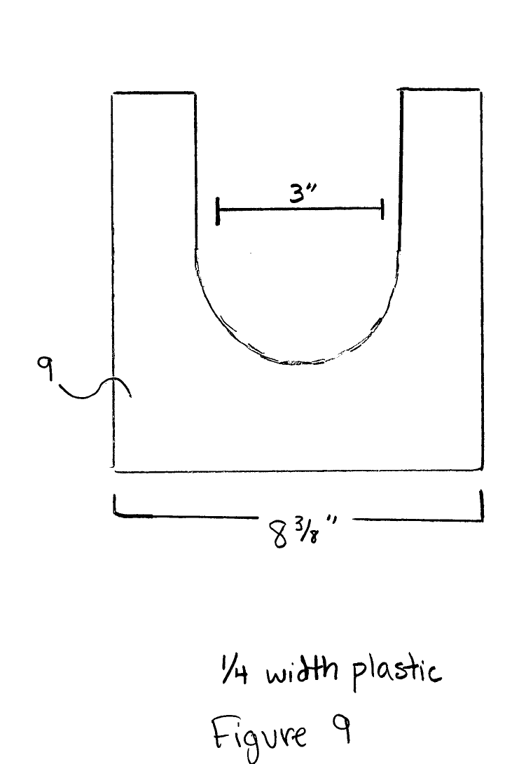

FIG. 10. FIG. 10 de3picts an alternative style clip in insert, (side view), used for both cutting blades and grinding wheels.

FIG. 11. Picture of the top view of FIG. 10.

FIG. 12. Actual clip of the insert in a blown up view.

FIG. 13. A diagrammatic top view of the groove style insert.

FIG. 14. Identifies the way the inserts and the-blank areas would work in conjunction within the box.

### DESCRIPTION OF THE ITEMS IN THE DRAWINGS

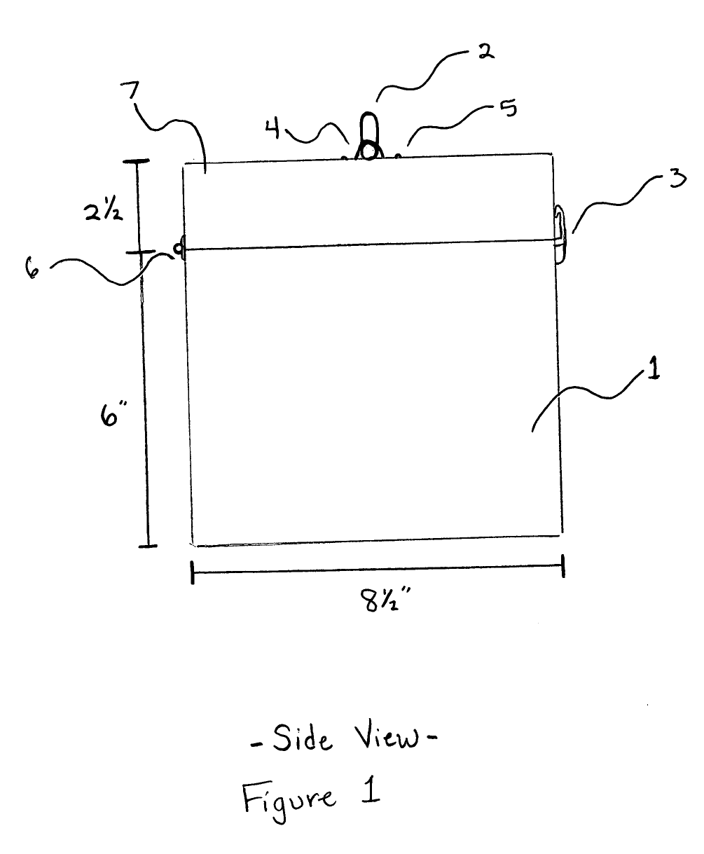

In FIG. 1, the external shell of the box (4), is connected to the lid portion of the design (7) by a single conventional hinge (6) running the full width of the box. At the top of FIG. 1 is the handle and means by which the present invention becomes portable. The handle is another standard or conventional feature made with a hollow tubular grasp handle (2), metal rivets or screws anchoring the handle tie downs to the lid (5). On the face of (7)1) is a clasp buckle latch to secure the lid closed. Inside the box or bag, as will be discussed further below, will be plastic inserts (two styles) that hold blades and grinding wheels in order to support the construction trades.

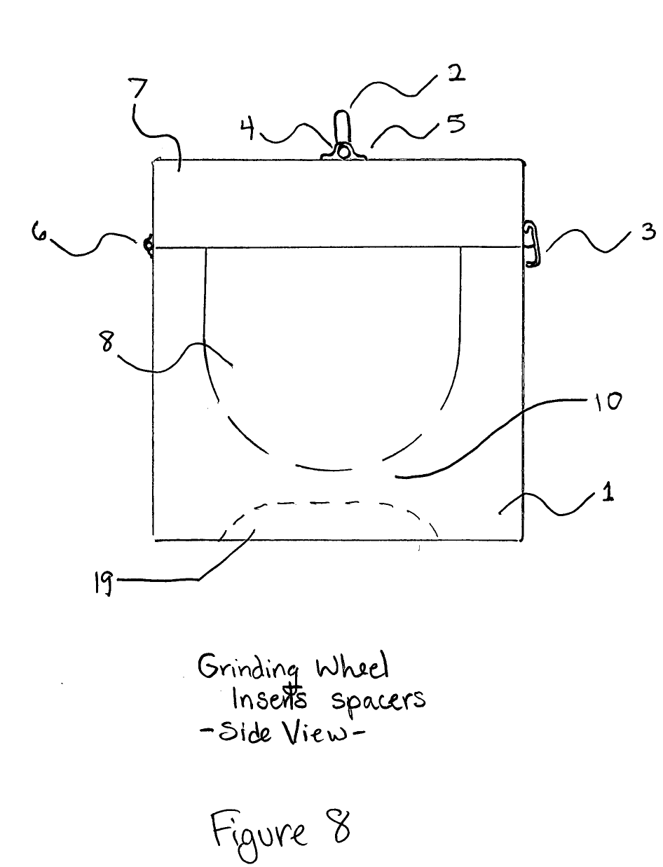

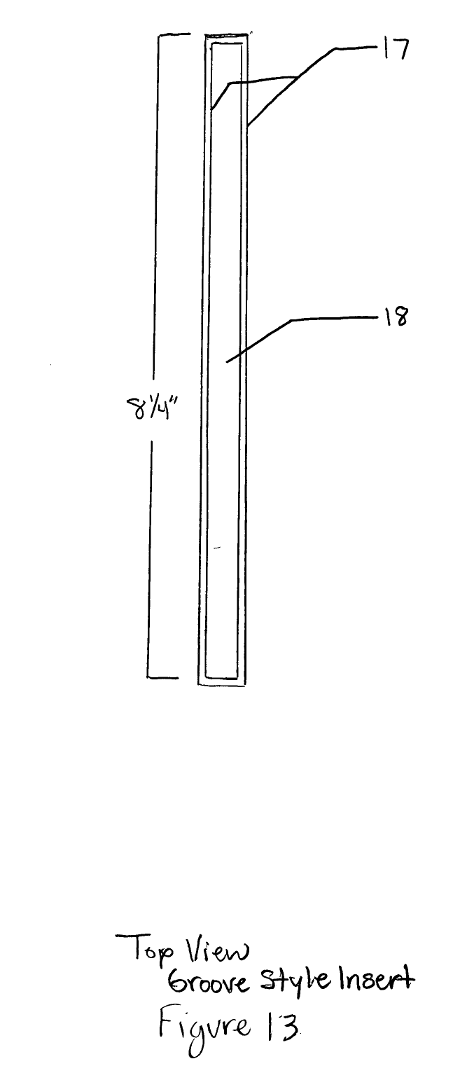

FIG. 8 is a side view of the invention, transparent, demonstrating how (10) would appear seated in the box. (10) is a groove style insert with a hollow center two ply design as shown in FIG. 13. Included with the recess of (10) for ease in removing the blade, (19) is an elevated bottom part of the insert. (19) allows the blade to be elevated for removal and is stationary. (19) would also assist the blade or wheel to remain centered in the storage space. (8) is the actual side view of the cut out space on a groove style insert. (9) is a sketch of the outside wall of the insert. Each groove style insert or spacer contains two (9) in its design with a hollow space in the center.

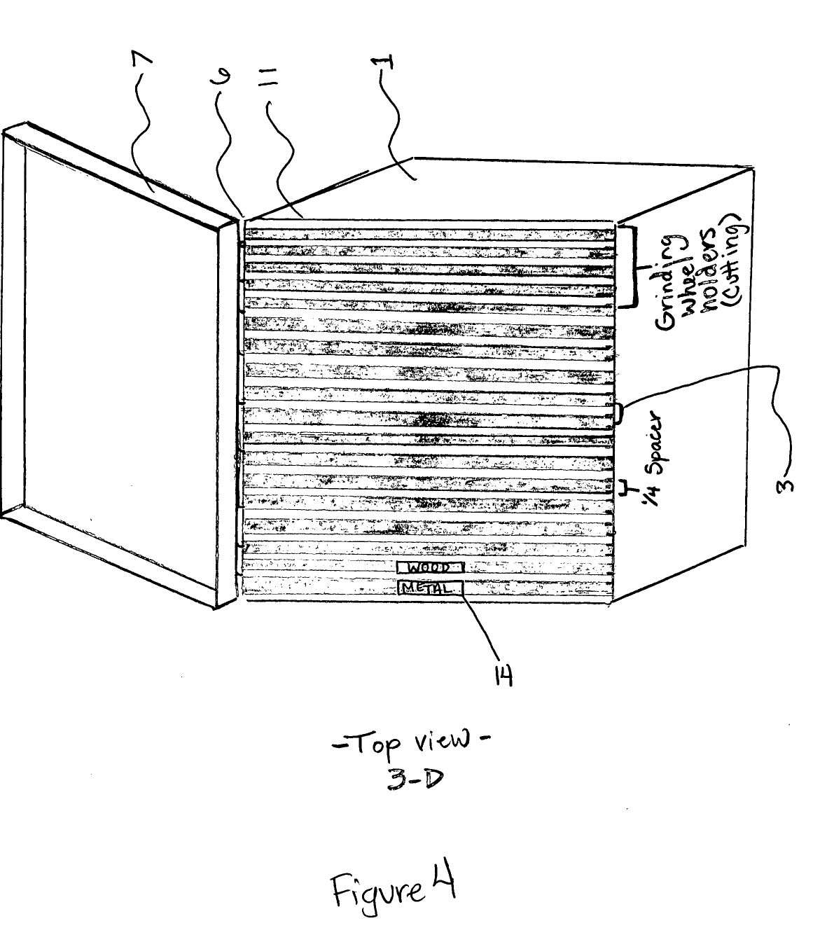

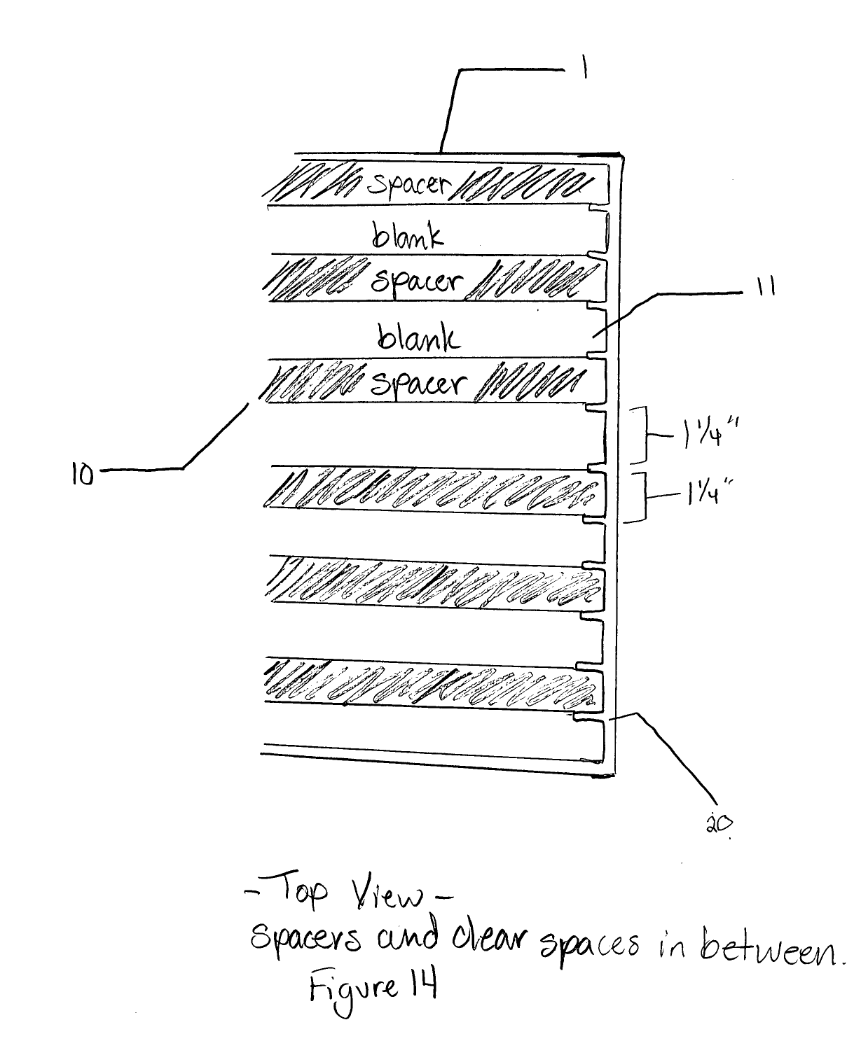

In FIG. 4, (11) can be seen from the top point of view. (11) is the clear empty space in between each of the inserts, measuring roughly ¼ of an inch. (11) can also be seen largely from the top in FIG. 14, incorporated with the groove style inserts. If the clip in inserts were used, the space (11) would still remain. (11) is kept clear, and the inserts held in place by tits on the sidewalls of the box itself, shown in FIG. 14, labeled (19). (12) shows how (19), (11) and (9) would all look in conjunction with the rest of the blade storage box.

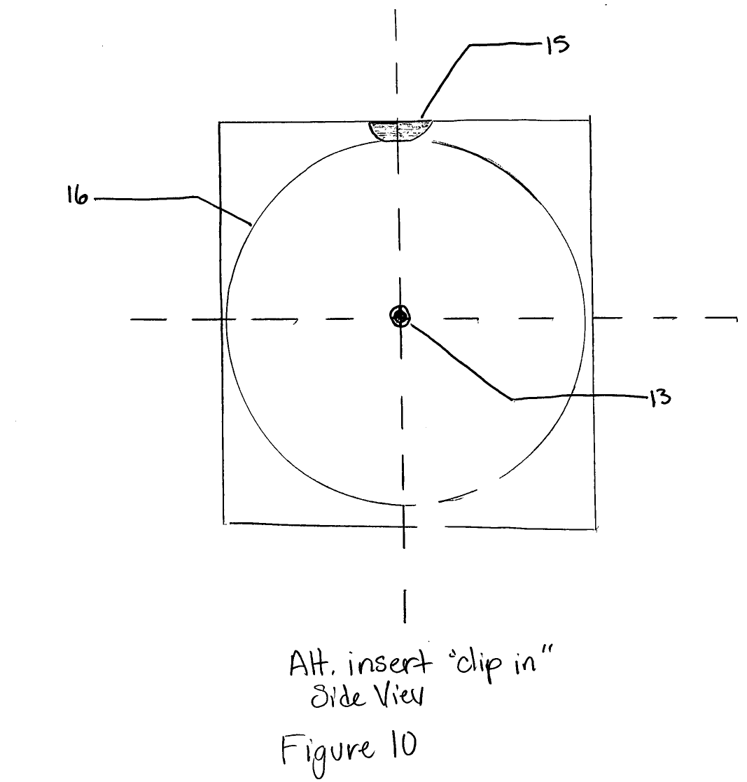

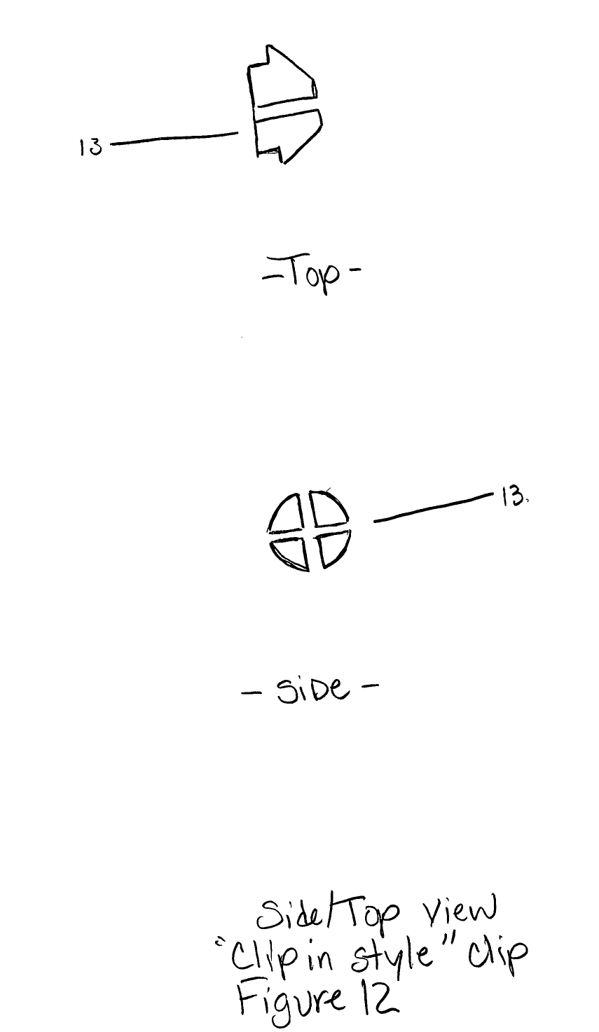

FIG. 10 is a picture demonstrating the side view of a clip in style insert. (13) is a picture of the actual clip part of the holder. As demonstrated in FIG. 12, (13) is located in the center of the insert. The four prong clip is inserted in the center of the arbor hole on the blade or wheel would expand once pushed through the hole. When completely through would expand in order to grip the blade tightly, securing it into place in the insert. (14) is a label located on the clip in holder, by which a person would identify the blade located within.

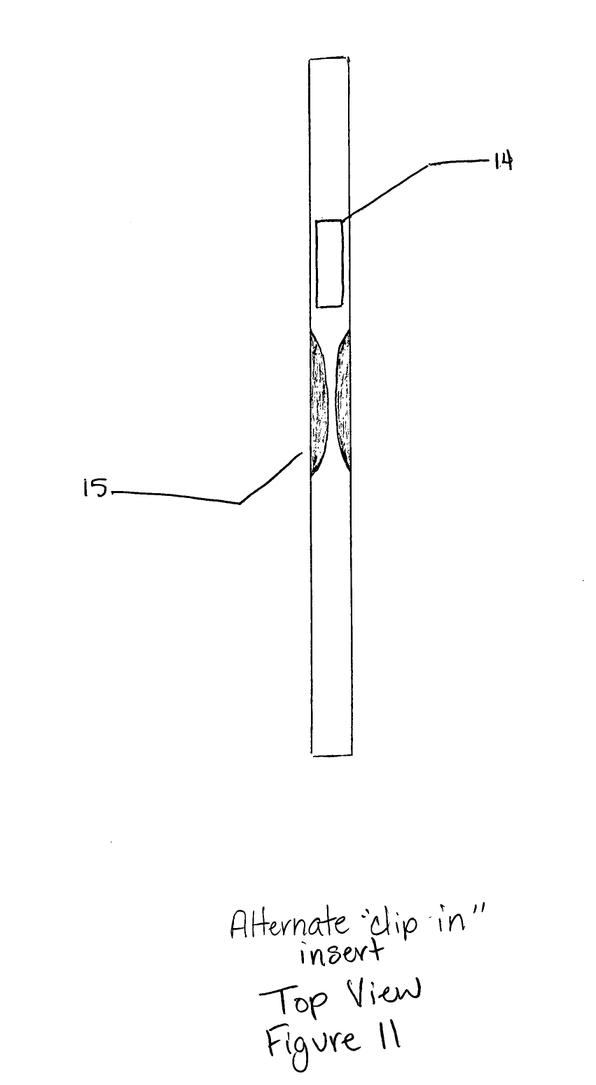

In FIG. 10 and 11, item (15) is the general location and shape of the gripping portion of the clip in style insert. The indentation, in the approximate center of the top of each insert, would allow a person to remove the blade containing insert from the box by grasping the indented handle with their pointer and thumb finger in order to remove it from the box.

FIG. 10 also shows (16). (16) is the recessed portion of the clip in holder or insert. The recession would measure roughly 7 and ⅝ inches for a saw blade. (16) would be circular and allow a blade to clip into (13) and fit in the recessed area. (16) would safeguard teeth and allow smooth insertion into the box for storage.

(17) in FIG. 13, is the thin, outside, hard plastic wall of the groove style insert which would, there in, contain the blade in (18). (18) being the hollow groove in which a circular blade would seat in each insert. The groove style insert allows complete containment of the blade teeth, which like the clip in insert safeguards teeth and allows for smooth insertion into the box.

In FIG. 14, (20) can be identified as part of the exterior side wall of the present invention. (20) is a “tit” guide to hold the inserts in place and maintain the blank space in between them. (20) would also help prevent the inserts from moving around inside the box.

1. A combined use method for storing circular saw blades in a mobile storage container. The container is made of heavy duty plastic, or a lightweight, durable metal. The method for organizing and storing blades and grinding wheels by providing a container designed to hold circular cutting tool accessories with a box, lid and removable inserts that would stow each individual blade. The lid would be attached to the box by a hinge and physically latch closed. The lid to the container would latch to the base, in doing so, keep the inserts contained and safeguarded.

2. The storing of claim 1 is keeping blades in the inserts within the box and in one specific location for the user.

3. The mobile of claim 1 is referring to the container itself which is small and compact enough for a person To carry around or to fit inside of another container such as a toolbox, bucket or behind a truck seat. It would be equipped with a handle for the ease of carrying.

4. The lightweight metal of claim 1 is an aluminum or tin rigid enough to hold up against the weight of the blades and wheels contained within, but light enough so that when holding blades, the container could still be carried easily by a single person.

5. The heavy durability, rigid plastic refers to the materials ability to withstand wear and tear in the workplace and rigid is suggesting that the plastic not be flexible or lose its shape as necessary to contain the inserts.

6. The 7¼″ blades referred to in claim 1 are circular blades or “skilsaw” blades used on a project for the intended use of cutting a specific material when placed on a worm-rive circular saw.

7. The box or base in claim 1 is the lower portion of the invention in which the inserts would actually seat before the lid was pulled closed and latched.

8. The stowing is referring to the container's ability, when fully closed, to keep water and other fluids from damaging the blades. It would also safeguard by keeping other tools, materials, etc., from chipping or breaking the teeth of any of the blades contained within.

9. The inserts described briefly in claim 1, refer to the individual blade containers each blade would be placed in before going into the box or base.
